(19) United States
(12) Patent Application Publication
(10) Pub. No.: US 2023/0120763 A1
(43) Pub. Date: Apr. 20, 2023

(54) Offset Pressure Prediction Based Pumping Schedule Generator for Well Interference Mitigation

(71) Applicant: Halliburton Energy Services, Inc., Houston, TX (US)

(72) Inventors: Baidurja Ray, Cypress, TX (US); Sergei Parsegov, Houston, TX (US); Tirumani Swaminathan, Houston, TX (US); Daniel Joshua Stark, Rowlett, TX (US)

(21) Appl. No.: 17/451,604

(22) Filed: Oct. 20, 2021

(51) Int. Cl. G06Q 10/06; E21B 43/26; E21B 47/06; E21B 49/00; G06N 20/00

(52) U.S. Cl. CPC G06Q 10/06311; E21B 43/2607; E21B 47/06; E21B 49/00; G06N 20/00; E21B 2200/20; E21B 43/267

(57) ABSTRACT

A machine learning model trained to predict offset pressure (“predictor”) is used to generate a pumping schedule that mitigates well interference during a hydraulic fracturing treatment operation. Diverse candidate pumping schedules are generated according to pumping schedule constraints. Feature inputs are populated with the candidate pumping schedules and with static and dynamic features related to the operation. The feature inputs are fed into one or more instances of the predictor to obtain offset pressure predictions at a prediction horizon for which the predictor was configured. The offset pressure predictions are evaluated to identify the one that best satisfies a well interference mitigation objective and the corresponding candidate pumping schedule is identified for well interference mitigation.

### BACKGROUND

The disclosure generally relates to Class 706 (Data Processing; Artificial Intelligence (AI))/Subclass 902 (Application Using AI) and to Class 405 (Hydraulic and Earth Engineering)/Subclass 129.1 (Subterranean Waste Disposal, Containment, or Treatment).

During hydraulic fracturing treatment, well interference can occur. Well interference refers to the expansion of fracture system from a treatment/child well to an offset/parent well(s) and resulting propagation of pressure front and fluid movement. Well interference mitigation involves the minimization of the well-to-well fluid pressure communication from well interference during the hydraulic fracturing treatment.

### BRIEF DESCRIPTION OF THE DRAWINGS

Embodiments of the disclosure may be better understood by referencing the accompanying drawings.

FIG. 1 illustrates an example system for a selection of a generated proposed pumping schedule that mitigates well interference based on offset pressure predictions from an ensemble of trained offset pressure predictors.

FIG. 2 is a flowchart of example operations to select a pumping schedule to mitigate detected well interference based on offset pressure predictions.

FIG. 3 is a flowchart of example operation for training a machine learning model to generate an offset pressure prediction based on hydraulic fracturing treatment data.

FIG. 4 depicts an example computer system with an offset pressure prediction based pumping schedule generator to mitigate well interference.

### DESCRIPTION

The description that follows includes example systems, methods, techniques, and program flows that embody embodiments of the disclosure. However, it is understood that this disclosure may be practiced without these specific details. For instance, this disclosure refers to a cross-well pressure and fluid communication initiated during a hydraulic fracturing treatment (“frac hit”) in illustrative examples for well interference mitigation. Aspects of this disclosure can be applied to other causes of well interference. In other instances, well-known instruction instances, protocols, structures, and techniques have not been shown in detail in order not to obfuscate the description.

### Overview

Well interference during hydraulic fracturing treatment or completions operations presents a costly challenge to those in the oil and gas industry who are unable to successfully mitigate well-to-well fluid communication during an active hydraulic fracturing operation. During completions, fractures will ideally penetrate a reservoir to create low resistance pathways for hydrocarbons previously unreachable by conventional means. In certain cases, fractures will instead propagate towards other existing wellbores because of the lower pressure regimes these offset wells create. On an example five-well pad, one well is treated at a time while the other offset wells are not. Traditional practice for mitigating well interference during an active hydraulic fracturing operation is to shut in offset wells or fill the offset wellbores with fluid under pressure while the treatment well undergoes completion. As a result, the shut-in offset wells build pressure for the purpose of preventing fracture growth into their vicinities.

A pumping schedule generator that generates a pumping schedule to mitigate well interference is disclosed herein. The pumping schedule generator can select a trained machine learning model architecture from multiple trained machine learning models, each of which has been designed according to different hyperparameters, which best satisfies selection parameters corresponding to the hyperparameter (e.g., prediction horizon). After model selection, the selected machine learning model is instantiated based on the selected, trained machine learning model. The schedule generator generates a feature input for each of a diverse set of candidate pumping schedules. The schedule generator also populates the feature inputs with dynamic and static features corresponding to a hydraulic fracturing operation. The scheduler generator then feeds each of the feature inputs into the instantiated model and evaluates the output offset predictions. Embodiments can instantiate multiple of the selected model to run the instances in parallel and evaluate the parallel outputs. The collection of instances of the trained machine learning model can be considered an ensemble of machine learning models. Embodiments can form an ensemble from the selected model(s) with other techniques (e.g., bagging, boosting, stacking). The pumping schedule generator evaluates the offset pressure predictions against a well interference mitigation objective. The pumping schedule generator then selects the proposed pumping schedule corresponding to the offset pressure prediction that best satisfies the well interference mitigation objective.

### Example Illustrations

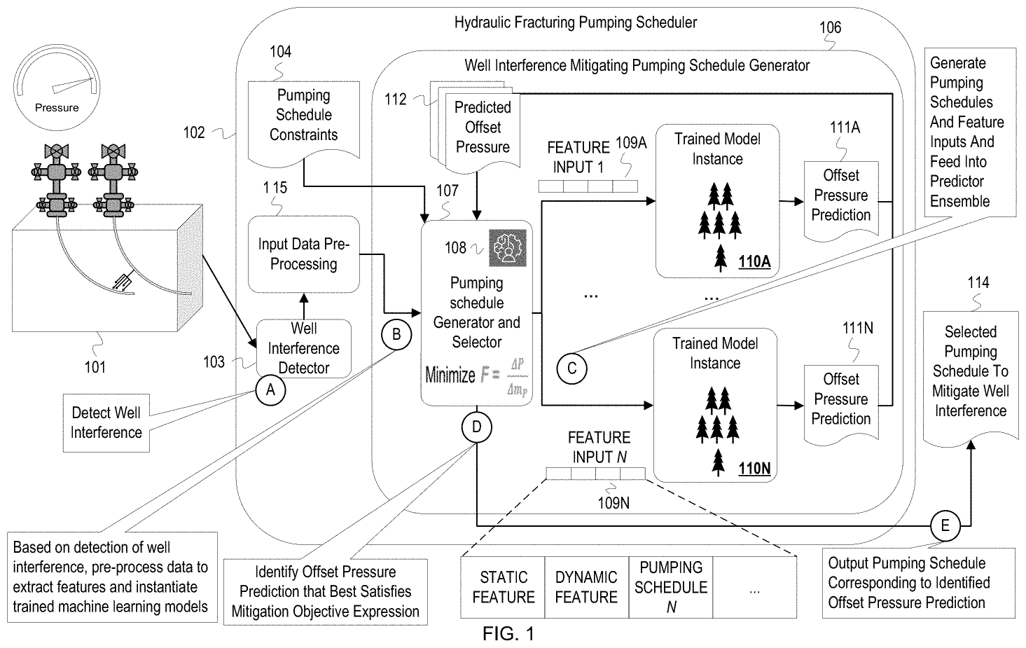

FIG. 1 illustrates an example system which selects a proposed pumping schedule for well interference mitigation based on offset pressure predictions from an ensemble of trained machine learning models. FIG. 1 depicts a hydraulic fracturing pumping scheduler 102 that includes a well interference mitigating pumping schedule generator 106. The hydraulic fracturing pumping scheduler 102 is program code that allows parameters to be defined for a hydraulic fracturing pumping schedule. Example parameters to be defined for a hydraulic fracturing pumping schedule include a slurry rate, a proppant concentration, and fluid additives (friction reducer types and concentrations). The well interference mitigating pumping schedule generator 106 includes a pumping schedule generator and selector 107 and a repository of trained machine learning models 108. Each of the trained machine learning models 108 have been trained to generate an offset pressure prediction based on static hydraulic fracturing features, dynamic hydraulic fracturing features, and a pumping schedule. Each of the trained machine learning models 108 have been designed with different hyperparameters and trained to output an offset pressure prediction, which can be a single predicted offset pressure value or a time-series of predicted offset pressure values. A well interference detector 103 monitors offset well pressure data from pressure sensors to detect well interference. Although illustrated as a component of the hydraulic fracturing pumping scheduler 102, the well interference detector 103 can be implemented separately and communicate detected well interference to the hydraulic fracturing pumping scheduler 102.

FIG. 1 refers to a cross-sectional illustration of an example well pad 101 illustrated with a treatment well, an offset well, and an instance of well interference in the subsurface in the form of fractures propagating from the treatment well to the offset well. While a frac site and associated equipment are not illustrated, the instances of well interference disclosed in this application occur during a hydraulic fracturing operation or well treatment operation. Well interference can instead or precedingly occur as poroelastic stress shadowing, wherein a growing hydraulic fracture or series of fractures cause a comparably minor pressure rise in an offset well without inducing fluid communication between the affected wells. The example well pad 101 portrays a single treatment well and single offset well for simplicity. An existing well pad in a hydraulic fracturing operation is not limited to one offset well and will often comprise multiple offset wells during the performance of a hydraulic fracturing treatment on a single treatment well. A pressure gauge measuring an arbitrary high pressure value is depicted above the offset well to denote the collection of offset well pressure data to be analyzed by program code in the hydraulic fracturing pumping scheduler 102. The instance of well interference in example well pad 101 can be detected from a rise in pressure of the offset well (“offset pressure”). Pressure measurement collection for the well pad 101 is ongoing. FIG. 1 is annotated with letters A-D to indicate stages of operations. The stages of operations can overlap, and each stage can include one or more operations. The series of stages are provided to aid in understanding the example illustration of FIG. 1 and not to limit claim scope.

At stage A, the well interference detector 103 detects well interference and indicates the detection of well interference The well interference detector 103 monitors the offset pressure data for each offset well. To distinguish the offset pressure data across wells, the treatment well can be identified to the well interference detector 103 (e.g., based on commencement of a treatment operation or via a user interface) and the data of different wells tagged to distinguish wells or written to a memory/storage space allocated specifically for an individual well. The well interference detector 103 can indicate the detected well interference, for example, by updating a user interface with a notification and/or inter-process communication to the pumping scheduler 102.

At stage B, a trained machine learning model is selected from the trained machine learning models 108 and instantiated as an ensemble. In addition, offset pressure data is pre-processed according to the selected, trained machine learning model. If the pumping schedule generator and selector 107 is not yet invoked, then it is invoked based on indication of well interference detection. Selection of the trained machine learning model from the trained machine learning models 108 can be based on previously specified selection parameters or selection parameters entered based on the detected well interference. The selection parameters correspond to model hyperparameters. As an example, selection parameters of a time step and prediction horizon may be selected based on job/stage duration remaining and other relevant factors at the time. The pumping schedule generator and selector 107 then selects from the trained machine learning models 108 based on a best match between the selection parameters and the defined model hyperparameters. FIG. 1 depicts a random forest type of model as an example. After model selection, the pumping schedule generator and selector 107 pre-processes obtained well data (e.g., offset pressure data) to shape into a feature for the selected, trained machine learning model (hereinafter selected model or predictor). This will be explained in more detail in the flowcharts. The pumping schedule generator and selector 107 also instantiates N of the selected model, which yields the trained model instances 110A-110N.

At stage C, the pumping schedule generator and selector 107 generates candidate pumping schedules and feature inputs. The pumping schedule generator and selector 107 generates N candidate pumping schedules which differ per trained model instance. Each of the candidate pumping schedules is a feature in a corresponding one of the feature inputs 109A-109N. The pumping schedule generator and selector 107 (hereinafter “schedule selector”), reads or obtains pumping schedule constraints 104. The pumping schedule constraints 104 indicate available values for parameters that are set to define a pumping schedule. Availability of values can be indicated as a range or listing. Some parameters may have a single available value. In addition, a pumping schedule parameter can have a dependency on another pumping schedule parameter that reduces the available values. Dependencies can be encoded into logic that dynamically adjusts the indications of available values for parameters. With the constraints 104, the schedule selector 107 generates multiple candidate pumping schedules based on an existing, planned pumping schedule. The scheduling generator 107 can generate the candidate pumping schedules from the planned pumping schedule according to different implementations and/or configurations. The schedule selector 107 can be configured (e.g., with a user interface (UI) menu) to modify m of the scheduling parameters of the planned pumping schedule that have a corresponding constraint in the schedule constraints 104. For each of the m scheduling parameters, the schedule generator 104 selects from the values indicated as available. At least one parameter of each candidate pumping schedule will have a different selected value. As another example, the schedule selector 107 can be configured or implemented to modify a different parameter to create each of the candidate pumping schedules. The schedule constraints 104 include predefined constraints and dynamic constraints that can change based on current state of the pad or offset well. Examples of predefined pumping schedule constraints include a target and minimum proppant mass to be pumped, a target and minimum clean fluid volume to be pumped, a minimum and maximum slurry rate, a minimum and maximum proppant concentration, a maximum length of time allotted to complete each stage, etc. Predefined pumping schedule constraints are operational constraints or controls decided before commencing the well treatment operation. Dynamic pumping schedule constraints are operational constraints that arise during a well treatment operation. An example dynamic constraint is available pump horsepower. A number of pumps failing during a well treatment is a hindrance on higher flow rates; the reduced cumulative horsepower across all pumps in the operation would reduce a maximum possible slurry rate among. The dynamic constraints can be adjusted throughout a treatment operation based on automated monitoring of the treatment systems and operation and/or manual input. Domain knowledge is used to create the pumping schedule constraints 104.

FIG. 1 illustrates example feature inputs 109A—109N to be input into the ensemble of trained model instances 110A-110N Each of the feature inputs 109A-109N will include one of the candidate pumping schedules, static hydraulic fracturing features, and dynamic hydraulic fracturing features. The static hydraulic fracturing features (“static features”) are extracted from static data established prior to the treatment operation and the dynamic hydraulic fracturing features (“dynamic features”) are extracted from data of the current treatment operation that can exhibit changes during the treatment operation. Examples of static features include wellbore spacing, stage length, cluster length, number and location of holes shot, petrophysical rock properties, geomechanical rock properties, and number of perforations. These may be input initially into the hydraulic pumping scheduler 102. Examples of dynamic features include offset pressure, slurry rate, and proppant concentration.

At stage D, the schedule selector 107 evaluates the offset pressure predictions received from the trained model instances 110A-110N. The pumping schedule selector 107 evaluates predicted offset predictions 112 against a mitigation objective to identify the offset pressure prediction that best satisfies the mitigation objective. Generally, the mitigation objective is to minimize or lower the pressure of the offset well(s) affected by the well interference. FIG. 1 depicts an example well interference mitigation objective expressed as Minimize F=ΔP/Δmₚ. The expression represents minimizing a change in pressure of an offset well (ΔP) per unit mass of proppant pumped (Δmₚ), with F representing the objective. The schedule selector 107 will evaluate each of the offset predictions 112 against the mitigation objective expression. Upon identifying the prediction that best satisfies the mitigation objective, the schedule selector 107 selects the candidate pumping schedule corresponding to the identified offset pressure prediction. For instance, the schedule selector 107 would select the candidate pumping schedule used to create the feature vector 109A if the identified offset pressure prediction is the offset pressure prediction 111A.

At stage E, the schedule selector 107 outputs a selected pumping schedule 114 that corresponds to the offset pressure prediction identified as best satisfying the mitigation objective. Outputting the selected pumping schedule 114 can take different forms. For example, outputting the pumping schedule 114 can be outputting the pumping schedule 114 to a user interface engine that updates a user interface to indicate the pumping schedule 114. As another example, outputting the pumping schedule 114 can be outputting the pumping schedule 114 to a controller of the fracturing system for automatic implementation.

The ensemble of trained predictors can be run multiple times. The runs can be multiple sets of single runs or multiple runs with a feedback loop. In the prior case, observations can be made of the dynamic variables (either or both of the dynamic schedule constraints and the dynamic features) and accounted for in generating candidate pumping schedules in a subsequent run and/or accounted for in a feature input for the subsequent run. In addition to the observations to information updating of dynamic variables, additional data can arrive to be incorporated into feature inputs of a subsequent run. Furthermore, subsequent runs before end of a treatment operation or treatment stage can be made with a different selected model. Model selection may change between runs based on operator preference or knowledge, passage of time, and/or updating of available trained models. For the latter case of chained model runs, embodiments can use the output offset pressure predictions of a current run to update the feature inputs for a subsequent run. Since degradation can occur from using predictions as features, increasing degradation would be expected in a longer chain of runs. Embodiments can limit allowable consecutive runs that use predictions in feature inputs when approaching or arriving at an unacceptable threshold of degradation (e.g., 3 consecutive feedback runs). These subsequent runs may be made when a prediction horizon is desired that is beyond the prediction horizon of the available trained models.

The following flow charts depict example operations for the selection of a pumping schedule based on offset pressure predictions and the process of training an offset pressure predictor prior to its deployment to an ongoing hydraulic fracturing operation. While the flowcharts refer to a schedule selector for consistent naming with the preceding Figures, naming and organization of program code can be dependent upon programming language, platform, development guidelines, and/or may be arbitrary (e.g., developer preferences). Thus, the scope of the claims is not constrained by any naming or organization of the example flowcharts.

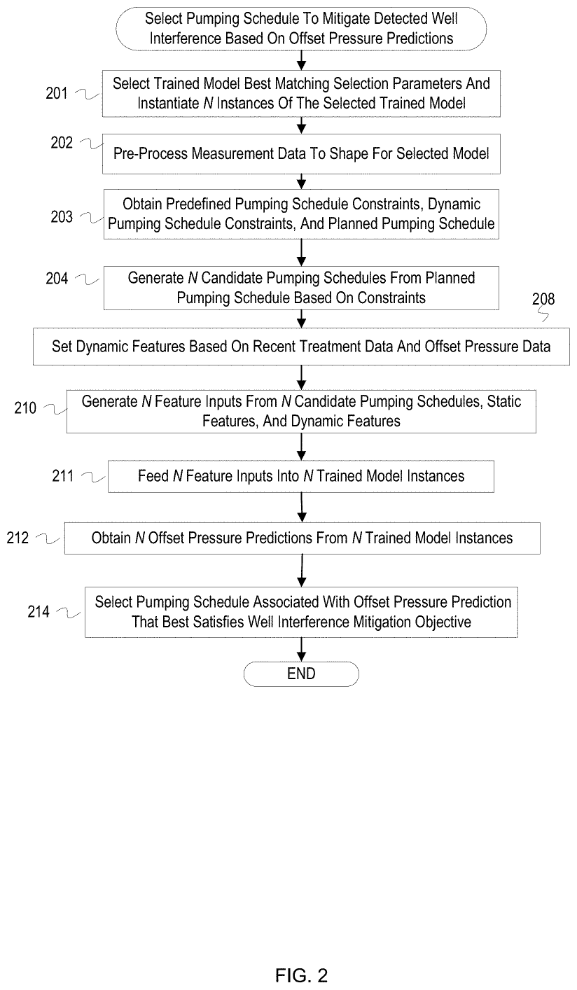

FIG. 2 is a flowchart of example operations to select a pumping schedule to mitigate detected well interference based on offset pressure predictions. The operations of FIG. 2 are triggered responsive to detection of well interference. As noted earlier, the relationship between detection of well interference and triggering of the example operations can vary—manual or automated. For example, the example operations can be triggered by user input after an operator receives a notification of well interference. As another example, well interference detection can launch a process or thread that selects a pumping schedule based on offset predictions.

At block 201, the schedule selector selects a trained machine learning model that best matches a selection parameter(s) and instantiates N instances of the selected model. To illustrate, an operator can choose model selection parameters time step (e.g., 10 seconds) and prediction horizon (e.g., 30 time steps or 5 minutes). If available, the schedule selector will select a trained model with a time step hyperparameter of 10 seconds and a prediction horizon hyperparameter of 30 time steps. Some of the features to be input into the trained model, for example offset pressure data, are expected to be time-series data having a data resolution of 10 seconds (i.e., measurement data at a time granularity of 10 seconds) for a model with a time step hyperparameter of 10 seconds. With a prediction hyperparameter of 30 time steps, a model will have been designed and trained to output an offset pressure prediction for a 5 minute forward offset from a time t, which corresponds to a most recent datum in a time-series feature. A matching trained model may not be available. Embodiments can apply matching rules to select from available trained models the one that is most suitable/appropriate for the selection parameters. As an example, a rule may be to select the trained model that is closest to the selection parameters without exceeding them. After selecting a trained model, the schedule selector instantiates N instances of the selected model. The number of instances can be configurable or hard coded. Embodiments may use a single instance of the selected model. To form an ensemble from the model instances, the schedule selector can wrap the program code that invokes the model instances with program code that collects the outputs for evaluation. Embodiments can also wrap the program code of the model instances with program code that pre-processes data, generates the feature inputs, and directs the feature inputs to the appropriate ones of the model instances.

At block 202, the schedule selector pre-processes measurement data to shape the measurement data for the selected model. In addition to the aforementioned hyperparameters, the selected model will have a hyperparameter for length of time-series features, which can be considered a historical length or time span hyperparameter. Assuming the 10 second time step hyperparameter and a historical length hyperparameter set to 10 time steps or 100 seconds, the schedule selector will pre-process measurement data to represent 10 second intervals spanning 100 seconds backwards from t. With offset pressure data being measured at a higher frequency than once each 10 seconds (usually better than 1 Hz), the schedule selector will apply statistical analysis to obtain offset pressure data shaped according to the hyperparameters and representing the collected offset pressure data better than sampling, although embodiments can implement sampling. The time-series feature of offset pressure data is obtained by calculating a statistical representation based on the hyperparameters. The statistical representation can be median, mean, mean and standard deviation, etc. for the offset pressure measurements within the 10 second interval, depending upon the model design (i.e., what the trained model expected for the feature). Offset pressure data is not the only data that may be pre-processed before feature extraction. For example, treatment well pressure, proppant concentration, slurry rate, and/or friction reduction additives concentrations may be compressed to shape the data to the hyperparameters of the selected model.

At block 203, the schedule selector obtains pumping schedule constraints (predefined and dynamic) and a planned pumping schedule. The schedule selector can read the schedule constraints and the planned pumping schedule from memory/storage or retrieve the data from scheduling software distinct from the schedule selector.

At block 204, the schedule selector generates a plurality of candidate pumping schedules from the planned pumping schedule based on the pumping schedule constraints. The schedule selector will generate diverse candidate pumping schedules that vary by varying one or more of the parameters subject to the dynamic scheduling constraints of the planned pumping schedule. Thus, each of the candidate pumping schedules will be different. In the case of multiple runs of the schedule selector, a change to a dynamic feature can induce a change in a dynamic scheduling constraint. For example, if proppant concentration—a dynamic feature—was increased to a significant extent, a proppant load for the entire operation (total proppant pumped in pounds (lbs.) would also increase. An increase in proppant concentration has the potential to turn a pumpable slurry into an arduous paste if a coinciding clean fluid pumped volume (barrels of fluid which carries the proppant down to fractures) is not also increased. Limitations of available supplies, available pump power, etc. dictate that raising proppant concentration and clean fluid rate requires a compromise to occur because both increases may not be possible with a given limit of proppant and fluid at a higher-than-initial proppant concentration. The compromise itself then becomes an additional pumping schedule constraint. This represents change to a dynamic scheduling constraint induced by the changing of a dynamic feature. Embodiments, however, are not limited to generating the candidate pumping schedules from a planned pumping schedule. Embodiments can use other sources, for example a library of pumping schedules or historical pumping schedules, and select candidates from the source according to the scheduling constraints.

At block 208, the schedule selector sets the dynamic features based on recent treatment data and offset pressure data. As discussed earlier, dynamic features can comprise offset pressure, proppant concentration, and other features of a fracturing operation that will change as the operation progresses. Setting the dynamic features may be writing the features extracted from the pre-processed data into a staging area (memory space) along with other dynamic features that did not require pre-processing and static features for copying into a feature input data structure.

At block 210, the schedule selector generates N feature inputs from the N candidate pumping schedules, the static features, and the dynamic features. The data structure to accommodate a feature input may be a matrix, series of matrices, array, complex data structure, etc.

At block 211, the schedule selector feeds/inputs the N feature inputs to the N trained offset pressure predictors. Embodiments can instead serially feed the N feature inputs to a same instance of a trained model and aggregate the outputs for evaluation against the mitigation objective.

At block 212, the schedule selector obtains N offset pressure predictions from the N trained model instances. In embodiments with the model instances running in parallel, the offset pressure predictions are collected and submitted for evaluation. In embodiments that use a single model instance, each offset prediction can be sent for evaluation or the offset pressure predictions can be buffered until the Nth offset pressure prediction is generated.

At block 214, the schedule selector selects the candidate pumping schedule associated with the offset pressure prediction that best satisfies a specified well interference mitigation objective. The schedule selector evaluates each of the offset pressure predictions against the mitigation objective and identifies the one that best satisfies the mitigation objective. An earlier example of the mitigation objective was minimizing offset pressure per unit proppant mass, but another example is minimizing offset pressure rise per unit clean volume. Embodiments are not limited to determining whether an offset pressure prediction directly satisfies a mitigation objective. Embodiments can determine whether a mitigation objective is satisfied based on the offset pressure predictions. As examples, one or more derivatives of offset pressure or any variable directly derived from offset pressure can be evaluated to determine which offset pressure prediction best satisfies a mitigation objective.

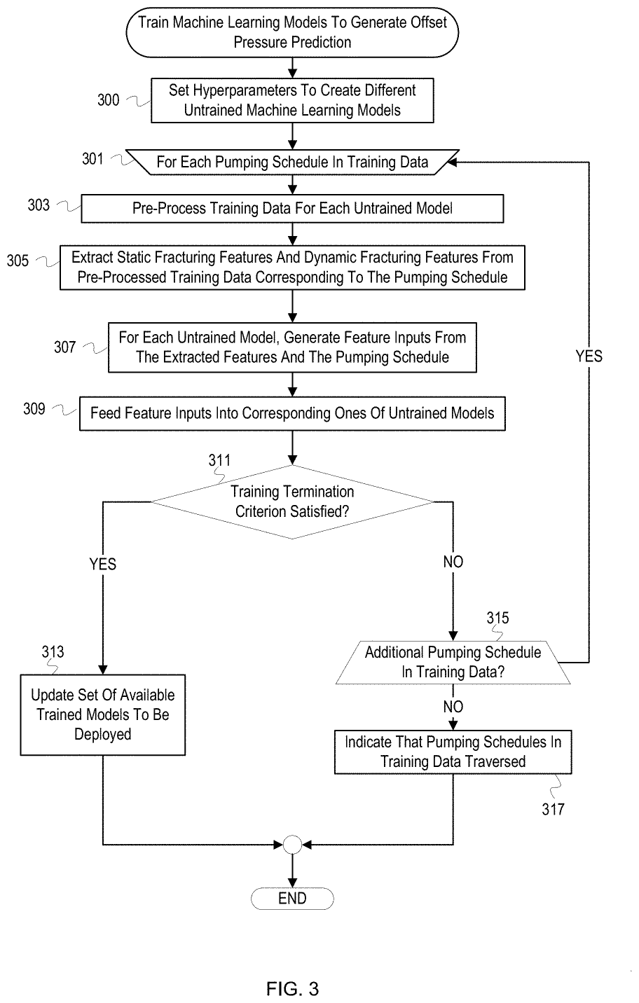

FIG. 3 is a flowchart of example operation for training a machine learning model to generate an offset pressure prediction based on hydraulic fracturing treatment data. FIG. 3 presumes feature engineering and experimentation have already been performed to select features from pumping schedules and treatment data that aid in predicting offset pressure. The training data can be sourced from historical data and/or from high fidelity hydraulic fracturing simulators. The flowchart is described with reference to a trainer as performing the example operations. The example training operations depicted in FIG. 3 are applied to a model type selected based on the feature engineering and experimentation. Multiple model types can be determined as useful. The above example refers to a random forest, but different decision-based models, such as XGBoost regressors can be used, as well as other classes of models, such as artificial neural networks. For each different model class/type, the training operations are performed, which would yield a more diverse set of available trained models.

Hyperparameters affect the prediction which can account for lead time. The formulas also take into account a lead time between control changes at the surface and systemic changes in the subsurface—there is a lag between the two. For example, a change in slurry rate via surface controls can take between 5-15 seconds on average to have a quantifiable effect on treatment pressure, while an increase or decrease in proppant concentration will often induce a longer lag time. When the updated proppant concentration reaches perforations in the treatment well, a distinct pressure change may be observable after 5-7 minutes

At block 300, the trainer sets hyperparameters to create different untrained machine learning models. As mentioned earlier, some of the hyperparameters include time step, prediction horizon, and a hyperparameter that indicates time-series length or duration (also referred to as historical time span), The different untrained models allow for creation of different trained machine learning models available for selection to suit selection parameters. The selection parameters may vary by operation preference, knowledge, and/or situation. The different configurations of untrained machine learning models may also account for varying response times of control variables in the pumping schedule.

At block 301, the trainer selects a pumping schedule for a current training iteration from a training data set. In addition to feature selection of treatment data determining the features to extract from treatment data, feature engineering may have been performed to determine which, if not all, of the parameters that define a pumping schedule to extract to form the pumping schedule feature.

At block 303, the trainer pre-processes training data for each untrained machine learning model. Since each untrained model is configured differently, the training data is shaped differently. The hyperparameters for one untrained model may pre-process the training data to create time-series features that cover a larger time span than another model. The trainer may compress the training data differently based on untrained models have different time step hyperparameter values. A trainer may extract a same amount of time-series data for untrained models with a same historical length hyperparameter but create time-series features of different sizes because of different time step parameters. In addition to the already noted reasons for having diverse available trained models, the different trained models can have different computing demands. Thus, model selection can also be informed by available computing resources of a deployment environment. The trainer can stage the features resulting from the data pre-processing for feature input population.

At block 305, the trainer extracts static fracturing features and dynamic fracturing features from the pre-processed data corresponding to the pumping schedule. Static features used to train the model are unique to each pumping schedule and are not expected to change during a treatment operation. Examples of the static features include well locations, petrophysical and geomechanical rock properties (e.g., permeability, rock moduli, leak-off behavior), number and location of perforation clusters, stage length, and the size and/or type of proppant selected. Examples of dynamic features include slurry rate, proppant concentration, and offset well pressure. For the time-series data that has been pre-processed, extracting the corresponding feature may be organizing the pre-processed data into a format to be consumed by an untrained model (e.g., an array within a feature input). While the source data is the same for the untrained models, the features will diverge due to the varying hyperparameter values/model configurations.

At block 307, the trainer generates a feature input for each of the untrained models from the pumping schedule feature and the extracted features of the corresponding one of the untrained models. Generating the feature input for each untrained model may yield a matrix, series of matrices, etc.

At block 309, the trainer feeds/inputs the generated feature inputs into the untrained models. For example, the trainer invokes each untrained model with the corresponding feature input as an argument, a reference to the feature input as an argument, or a list of arguments for each feature that constitutes the feature input.

At block 311, the trainer determines whether a training termination criterion is satisfied. A training termination criterion can specify a number of training runs or a stable deviation margin between expected and predicted values. Embodiments may use multiple training termination criteria. While training may terminate in parallel across the untrained models, the diversity of model configurations can lead to varying training runs until reaching termination criteria are satisfied. If the training termination criterion is not satisfied, then flow continues to block 315. Otherwise, flow continues to block 306.

At block 313, the trainer updates a set of available trained models for deployment. The available trained models can be deployed with a schedule generator solution (e.g., included as part of a software package), can be a remotely accessible repository of training models, can be deployed as part of a software-as-a-solution service, etc. After deployment, the trained models can undergo ongoing training and performance evaluation. If a deployed model fails to satisfy a performance criterion, then additional training can be performed. Alternatively, the deployed model can be retired/replaced.

At block 315, the trainer determines whether an additional pumping schedule and treatment data are available in the training data to continue training the models. If the training data has been exhausted, then the trainer indicates that all pumping schedules in the training data have been traversed at block 317. This can operate as a notification to obtain additional training data or repeat training with the same training data, perhaps in a different order. If there is an additional pumping schedule in the training data, then flow returns to block 301.

### Variations

As mentioned earlier, embodiments can use an ensemble of trained machine learning model instances to output offset predictions or repeatedly run a single instance of a trained machine learning model. In the example illustrations, the ensemble is a collection of multiple instances of a selected machine learning model. However, embodiments can store trained ensembles of machine learning models and repeatedly run the ensemble to obtain offset predictions or create multiple instances of the selected, trained machine learning model.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

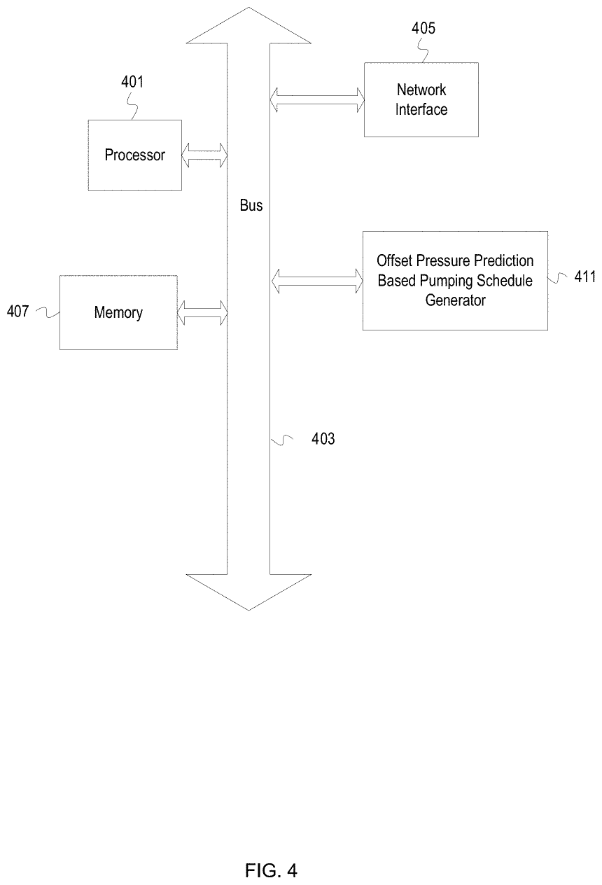

FIG. 4 depicts an example computer system with an offset pressure prediction based pumping schedule generator to mitigate well interference. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes an offset pressure prediction based pumping schedule generator 411. The offset pressure prediction based pumping schedule generator 411 generates varying candidate pumping schedules and populates feature inputs with the candidate pumping schedules. The offset pressure prediction based pumping schedule generator 411 also populates or instantiates feature inputs with static and dynamic hydraulic fracturing features. The offset pressure prediction based pumping schedule generator 411 feeds the feature inputs into one or multiple instances of a machine learning model that has been trained to output an offset pressure prediction. The offset pressure prediction based pumping schedule generator 411 evaluates offset pressure predictions output from the trained model instance(s) to identify the one that best satisfies a mitigation objective and the corresponding pumping schedule. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

While the aspects of the disclosure are described with reference to various implementations and exploitations, it will be understood that these aspects are illustrative and that the scope of the claims is not limited to them. In general, techniques for mitigating well interference as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Embodiment 1: A method comprising: based on detection of well interference during a hydraulic fracturing treatment operation, generating a plurality of candidate pumping schedules according to scheduling constraints, wherein the plurality of candidate pumping schedules are diverse; generating a plurality of feature inputs based, at least in part, on the plurality of candidate pumping schedules, static features corresponding to wells, and dynamic features corresponding to the hydraulic fracturing treatment operation; obtaining a plurality of offset pressure predictions based, at least in part, on a trained machine learning model and the plurality of feature inputs, wherein the trained machine learning model has been trained to output an offset pressure prediction; evaluating the plurality of offset pressure predictions with a well interference mitigation objective; and identifying the one of the plurality of candidate pumping schedules corresponding to a first offset pressure prediction based, at least in part, on evaluating the plurality of offset pressure predictions.

Embodiment 2: The method of embodiment 1 further comprising selecting the trained machine learning model from a plurality of trained machine learning models having diversity of settings of hyperparameters.

Embodiment 3: The method of embodiment 2, wherein selecting the trained machine learning model is based, at least in part, on one or more input selection parameter that specify a setting for at least one of the hyperparameters.

Embodiment 4: The method of embodiment 3, wherein selecting the trained machine model comprises determining which of the plurality of trained machine learning models most satisfies the one or more input selection parameters.

Embodiment 5: The method of any one of embodiments 1 to 4, wherein generating the plurality of candidate pumping schedules comprises generating the plurality of candidate pumping schedules based on a planned pumping schedule or a library of pumping schedules.

Embodiment 6: The method of any one of embodiments 1 to 5, wherein evaluating the plurality of offset pressure predictions comprises evaluating against the well interference mitigation objective, for each of the plurality of offset pressure predictions, at least one of the offset pressure prediction, a derivative of the offset pressure prediction, and a variable derived from the offset pressure prediction.

Embodiment 7: The method of any one of embodiments 1 to 6, wherein identifying the one of the plurality of candidate pumping schedules comprises determining that the well interference mitigation objective is best satisfied based, at least in part, on the first offset pressure prediction.

Embodiment 8: The method of any one of embodiments 1 to 7, wherein the dynamic features comprise at least one of offset pressure, slurry rate, and proppant concentration.

Embodiment 9: The method of any one of embodiments 1 to 8, wherein the static features comprise at least two of wellbore spacing, proppant type, number of perforation clusters, cluster length, location of perforation clusters, number and location of holes shot, stage length, petrophysical rock properties, and geomechanical rock properties.

Embodiment 10: The method of any one of embodiments 1 to 9, wherein the scheduling constraints comprise predefined pumping schedule constraints corresponding to controls defined before commencement of the hydraulic fracturing treatment operation and dynamic scheduling constraints corresponding to operational constraints that can change based on state of a pad or offset well.

Embodiment 11: A non-transitory, computer-readable medium having program code stored thereon, the program code comprising program code to: based on detection of well interference during a hydraulic fracturing treatment operation, generate a diverse plurality of candidate pumping schedules according to scheduling constraints; generate a plurality of feature inputs based, at least in part, on the diverse plurality of candidate pumping schedules, static features corresponding to wells of the hydraulic fracturing treatment operation, and dynamic features corresponding to the hydraulic fracturing treatment operation; obtain a plurality of offset pressure predictions based, at least in part, on a trained machine learning model and the plurality of feature inputs, wherein the trained machine learning model has been trained to output an offset pressure prediction; evaluate the plurality of offset pressure predictions with a well interference mitigation objective; and identify one of the diverse plurality of candidate pumping schedules based, at least in part, on evaluation of the plurality of offset pressure predictions.

Embodiment 12: The non-transitory, computer-readable medium of embodiment 11, wherein the program code further comprises program code to select the trained machine learning model from a plurality of trained machine learning models having diversity of settings of hyperparameters.

Embodiment 13: The non-transitory, computer-readable medium of embodiment 11 or 12, wherein the static features and the dynamic features repeat across the feature inputs.

Embodiment 14: The non-transitory, computer-readable medium of any one of embodiments 11 to 13, wherein the program code to generate the plurality of diverse candidate pumping schedules comprises program code to generate the diverse plurality of candidate pumping schedules based on a planned pumping schedule or a library of pumping schedules.

Embodiment 15: The non-transitory, computer-readable medium of any one of embodiments 11 to 14, wherein the program code to evaluate the plurality of offset pressure predictions comprises program code to evaluate against the well interference mitigation objective, for each of the plurality of offset pressure predictions, at least one of the offset pressure prediction, a derivative of the offset pressure prediction, and a variable derived from the offset pressure prediction.

Embodiment 16: The non-transitory, computer-readable medium of any one of embodiments 11 to 15, wherein the program code to identify one of the diverse plurality of candidate pumping schedules comprises program code to identify the one of the diverse plurality of candidate pumping schedules corresponding to the one of the plurality of offset pressure predictions that best satisfies the well interference mitigation objective based on the evaluation of the plurality of offset pressure predictions.

Embodiment 17: The non-transitory, computer-readable medium of any one of embodiments 11 to 16, wherein the dynamic features comprise offset pressure, slurry rate and proppant concentration and the static features comprise at least two of wellbore spacing, proppant type, number of perforation clusters, cluster length, location of perforation clusters, number and location of holes shot, stage length, petrophysical rock properties, and geomechanical rock properties.

Embodiment 18: The non-transitory, computer-readable medium of any one of embodiments 11 to 17, wherein the scheduling constraints comprise predefined pumping schedule constraints corresponding to controls defined before commencement of the hydraulic fracturing treatment operation and dynamic scheduling constraints corresponding to operational constraints that can change based on state of a pad or offset well.

Embodiment 19: An apparatus comprising: a processor; and a computer-readable medium having instructions stored thereon that are executable by the processor to cause the apparatus to, based on detection of well interference during a hydraulic fracturing treatment operation, generate a diverse plurality of candidate pumping schedules according to scheduling constraints; generate a plurality of feature inputs based, at least in part, on the diverse plurality of candidate pumping schedules, static features corresponding to wells of the hydraulic fracturing treatment operation, and dynamic features corresponding to the hydraulic fracturing treatment operation; obtain a plurality of offset pressure predictions based, at least in part, on a trained machine learning model and the plurality of feature inputs, wherein the trained machine learning model has been trained to output an offset pressure prediction; evaluate the plurality of offset pressure predictions with a well interference mitigation objective; and identify one of the diverse plurality of candidate pumping schedules based, at least in part, on evaluation of the plurality of offset pressure predictions.

Embodiment 20: The apparatus of embodiment 19 further comprising a repository of trained machine learning models having diversity of settings of hyperparameters, wherein the instructions further comprise instructions executable by the processor to cause the apparatus to select the trained machine learning model from the repository.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
based on detection of well interference during a hydraulic fracturing treatment operation, generating a plurality of candidate pumping schedules according to scheduling constraints, wherein the plurality of candidate pumping schedules are diverse;
generating a plurality of feature inputs based, at least in part, on the plurality of candidate pumping schedules, static features corresponding to wells, and dynamic features corresponding to the hydraulic fracturing treatment operation;
obtaining a plurality of offset pressure predictions based, at least in part, on a trained machine learning model and the plurality of feature inputs, wherein the trained machine learning model has been trained to output an offset pressure prediction;
evaluating the plurality of offset pressure predictions with a well interference mitigation objective; and
identifying the one of the plurality of candidate pumping schedules corresponding to a first offset pressure prediction based, at least in part, on evaluating the plurality of offset pressure predictions.

2. The method of claim 1 further comprising selecting the trained machine learning model from a plurality of trained machine learning models having diversity of settings of hyperparameters.

3. The method of claim 2, wherein selecting the trained machine learning model is based, at least in part, on one or more input selection parameter that specify a setting for at least one of the hyperparameters.

4. The method of claim 3, wherein selecting the trained machine model comprises determining which of the plurality of trained machine learning models most satisfies the one or more input selection parameters.

5. The method of claim 1, wherein generating the plurality of candidate pumping schedules comprises generating the plurality of candidate pumping schedules based on a planned pumping schedule or a library of pumping schedules.

6. The method of claim 1, wherein evaluating the plurality of offset pressure predictions comprises evaluating against the well interference mitigation objective, for each of the plurality of offset pressure predictions, at least one of the offset pressure prediction, a derivative of the offset pressure prediction, and a variable derived from the offset pressure prediction.

7. The method of claim 1, wherein identifying the one of the plurality of candidate pumping schedules comprises determining that the well interference mitigation objective is best satisfied based, at least in part, on the first offset pressure prediction.

8. The method of claim 1, wherein the dynamic features comprise at least one of offset pressure, slurry rate, and proppant concentration.

9. The method of claim 1, wherein the static features comprise at least two of wellbore spacing, proppant type, number of perforation clusters, cluster length, location of perforation clusters, number and location of holes shot, stage length, petrophysical rock properties, and geomechanical rock properties.

10. The method of claim 1, wherein the scheduling constraints comprise predefined pumping schedule constraints corresponding to controls defined before commencement of the hydraulic fracturing treatment operation and dynamic scheduling constraints corresponding to operational constraints that can change based on state of a pad or offset well.

11. A non-transitory, computer-readable medium having program code stored thereon, the program code comprising program code to:
based on detection of well interference during a hydraulic fracturing treatment operation, generate a diverse plurality of candidate pumping schedules according to scheduling constraints;
generate a plurality of feature inputs based, at least in part, on the diverse plurality of candidate pumping schedules, static features corresponding to wells of the hydraulic fracturing treatment operation, and dynamic features corresponding to the hydraulic fracturing treatment operation;
obtain a plurality of offset pressure predictions based, at least in part, on a trained machine learning model and the plurality of feature inputs, wherein the trained machine learning model has been trained to output an offset pressure prediction;
evaluate the plurality of offset pressure predictions with a well interference mitigation objective; and
identify one of the diverse plurality of candidate pumping schedules based, at least in part, on evaluation of the plurality of offset pressure predictions.

12. The non-transitory, computer-readable medium of claim 11, wherein the program code further comprises program code to select the trained machine learning model from a plurality of trained machine learning models having diversity of settings of hyperparameters.

13. The non-transitory, computer-readable medium of claim 11, wherein the static features and the dynamic features repeat across the feature inputs.

14. The non-transitory, computer-readable medium of claim 11, wherein the program code to generate the plurality of diverse candidate pumping schedules comprises program code to generate the diverse plurality of candidate pumping schedules based on a planned pumping schedule or a library of pumping schedules.

15. The non-transitory, computer-readable medium of claim 11, wherein the program code to evaluate the plurality of offset pressure predictions comprises program code to evaluate against the well interference mitigation objective, for each of the plurality of offset pressure predictions, at least one of the offset pressure prediction, a derivative of the offset pressure prediction, and a variable derived from the offset pressure prediction.

16. The non-transitory, computer-readable medium of claim 11, wherein the program code to identify one of the diverse plurality of candidate pumping schedules comprises program code to identify the one of the diverse plurality of candidate pumping schedules corresponding to the one of the plurality of offset pressure predictions that best satisfies the well interference mitigation objective based on the evaluation of the plurality of offset pressure predictions.

17. The non-transitory, computer-readable medium of claim 11, wherein the dynamic features comprise offset pressure, slurry rate and proppant concentration and the static features comprise at least two of wellbore spacing, proppant type, number of perforation clusters, cluster length, location of perforation clusters, number and location of holes shot, stage length, petrophysical rock properties, and geomechanical rock properties.

18. The non-transitory, computer-readable medium of claim 11, wherein the scheduling constraints comprise predefined pumping schedule constraints corresponding to controls defined before commencement of the hydraulic fracturing treatment operation and dynamic scheduling constraints corresponding to operational constraints that can change based on state of a pad or offset well.

19. An apparatus comprising:
a processor; and
a computer-readable medium having instructions stored thereon that are executable by the processor to cause the apparatus to,
based on detection of well interference during a hydraulic fracturing treatment operation, generate a diverse plurality of candidate pumping schedules according to scheduling constraints;
generate a plurality of feature inputs based, at least in part, on the diverse plurality of candidate pumping schedules, static features corresponding to wells of the hydraulic fracturing treatment operation, and dynamic features corresponding to the hydraulic fracturing treatment operation;
obtain a plurality of offset pressure predictions based, at least in part, on a trained machine learning model and the plurality of feature inputs, wherein the trained machine learning model has been trained to output an offset pressure prediction;
evaluate the plurality of offset pressure predictions with a well interference mitigation objective; and
identify one of the diverse plurality of candidate pumping schedules based, at least in part, on evaluation of the plurality of offset pressure predictions.

20. The apparatus of claim 19 further comprising a repository of trained machine learning models having diversity of settings of hyperparameters, wherein the instructions further comprise instructions executable by the processor to cause the apparatus to select the trained machine learning model from the repository.
